(19) United States
(12) Patent Application Publication
(10) Pub. No.: US 2009/0215408 A1
(43) Pub. Date: Aug. 27, 2009

(54) Locatable and Autonomously Powered Backscatter Transponder for Registering Measured Variables

(75) Inventors: Daniel Evers, Otterfing (DE); Peter Gulden, München (DE); Claus Seisenberger, Neufrannhofen (DE); Leif Wiebking, München (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Aktiengesellschaft, München (DE)

(21) Appl. No.: 11/989,822

(22) PCT Filed: Aug. 3, 2006
(86) PCT No.: PCT/EP2006/065040

§ 371 Date: Mar. 9, 2009

(30) Foreign Application Priority Data
Aug. 9, 2005 (DE) 10 2005 037 582.0

(51) Int. Cl. H04B 1/38

(52) U.S. Cl. 455/90.1

(57) ABSTRACT

There is described a backscatter system comprised of a base station and of a completely passive transponder. The transponder is capable of reading out quantities from sensors and an energy stand-alone manner, of transmitting the readout quantities to the base station, and to carry out a runtime-based and thus highly precise distance measurement between a completely passive tag and base station. The power supply of the transponder ensues from the radio field emitted by the base station.

The present invention relates to backscatter transponders that can be both supplied via the radio network with energy from a base station and also read out thereby.

RFID (Radio Frequency Identification) applications that operate using passive transponders are employed in various technical domains. Compared with active transponders, said passive transponders are of advantage owing to the costs required for them as well as their size, robustness, durability, and freedom from maintenance. Moreover, passive transponders require no additional local energy supply in the form of, for instance, a battery or solar cell.

Since conventional RFID tags or transponders usually transmit just one ID (identification) they are suitable for simple identification functions only. The functions requiring to be performed for a passive transponder are limited substantially by the energy available for said functions. Totally passive tags have therefore hitherto only been identified, while distance measuring between the base station and tags is generally barely possible via the field strength. Distance measuring is impeded especially in a metallic environment owing to constructive and destructive interference through multi-path propagating because that partially overcompensates the physical effect of the reduction in field strength with increasing distance between the base station and transponder.

The problem addressed by the present invention is thus to efficiently utilize the energy that is radiated via the radio field and limited by approval restrictions in order to allow a peripheral sensor system to be read out by the passive transponder and at the same time enable its locating by the base station.

The above problem is solved by means of a backscatter transponder having the following features: an energy supply for feeding the backscatter transponder with energy in such a way that the backscatter transponder can be supplied with energy via an HF field of a base station, a control means by means of which energy from the energy supply can be transmitted to sensors and measured values of said sensors read out, and a capability of performing contactless distance measuring between the base station and backscatter transponder.

The backscatter transponder is able in combination with a corresponding base station to read out additional sensors in an autonomously powered manner, transmit the read-out variables to the base station, and perform distance measuring that is based on propagation delay and so highly accurate between the passive transponder and base station at acceptable ranges of several meters. Highly accurate locating of the passive transponder or measuring of its distance from the base station is advantageous for, say, avoiding ambiguities when a plurality of passive transponders are used.

The transponder can optionally be embodied also as semi-passive, which is to say the microprocessor is fed via a local energy source.

The backscatter transponder is inventively supplied with energy via a narrowband radio signal while distance of the passive backscatter transponder is measured contactlessly by means of a broadband radio signal. The passive backscatter transponder communicates with a base station for producing and registering radio signals, which base station has the following features: a signal processing and driving component, a receiver by means of which a radio signal emitted by a backscatter transponder can be registered, and a transmitter by means of which a narrowband signal can be radiated as a first radio signal of a first frequency band for supplying the backscatter transponder with energy and a broadband signal can be radiated as a second radio signal of a second frequency band for locating the backscatter transponder.

If the energy supply and modulation unit of the backscatter transponder are supplied over the same frequency range of the base station's radio signal, then the backscatter transponder can be equipped with just one antenna and just one transmitter/receiver. That design optimizing measure can also be implemented in the same way in the base station. That will enable the use of a base station and backscatter transponder requiring little circuitry overhead because both supplying the backscatter transponder with energy and locating it or measuring its distance will be carried out within the same frequency range.

According to an embodiment variant the backscatter transponder is supplied with energy by means of a narrowband radio signal that is emitted by the base station at a first power, while the backscatter transponder is located by means of a broadband radio signal having a second power, with the first power being optimally greater than the second power owing to existing radio regulations.

The narrowband radio signal for supplying energy to the backscatter transponder and the broadband radio signal for locating it can be transmitted both in parallel and alternately. For example, the first radio signal is radiated by the base station in the 2.4 GHz range at a width of 8 MHz, while the second radio signal is in the 2.4 GHz range and has a width of 80 to 90 MHz. It is, though, likewise possible to use a first radio signal having a frequency of 869 MHz for supplying the backscatter transponder with energy and combine it with a second radio signal in the 2.4 GHz ISM band for distance measuring.

Precise distance measuring between the base station and passive or (for large ranges) semi-passive transponder is possible based on the invention summarized above. Transponder ranges of approximately 4 m passive and 15 m semi-passive can furthermore be implemented. To further support the backscatter transponder's performance capability, larger amounts of energy than could be utilized solely in the case of direct feeding from the radio field can be made temporarily available through using a power accumulator. Thanks to the modulation realizable in the backscatter transponder the entire autonomously powered locatable backscatter system has, moreover, multi-destination capability, which is to say that by means of said frequency division multiplexing method a plurality of backscatter transponders can be registered in a collision-free manner by one base station. It is furthermore of practical relevance that the radio signals emitted by the base station are approval-compliant.

Preferred embodiment variants of the present invention will emerge from the following description, the drawings, and the appended claims. Of the accompanying drawings:

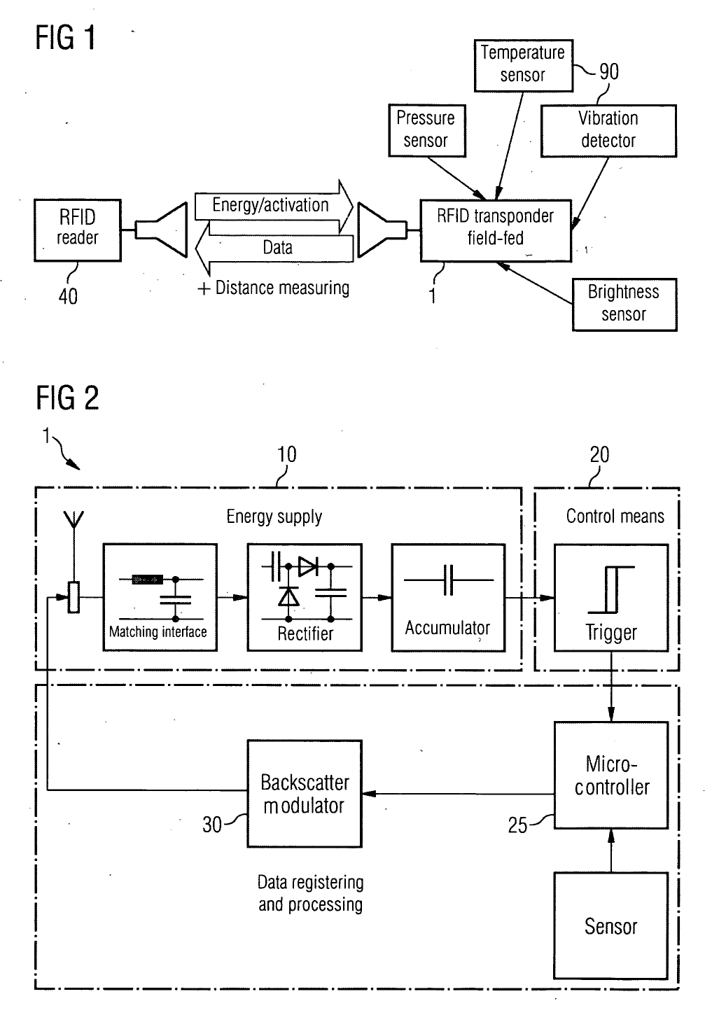

FIG. 1 shows an embodiment variant of the structure of the autonomously powered locatable backscatter system,

FIG. 2 is an exemplary block diagram of the autonomously powered locatable backscatter transponder,

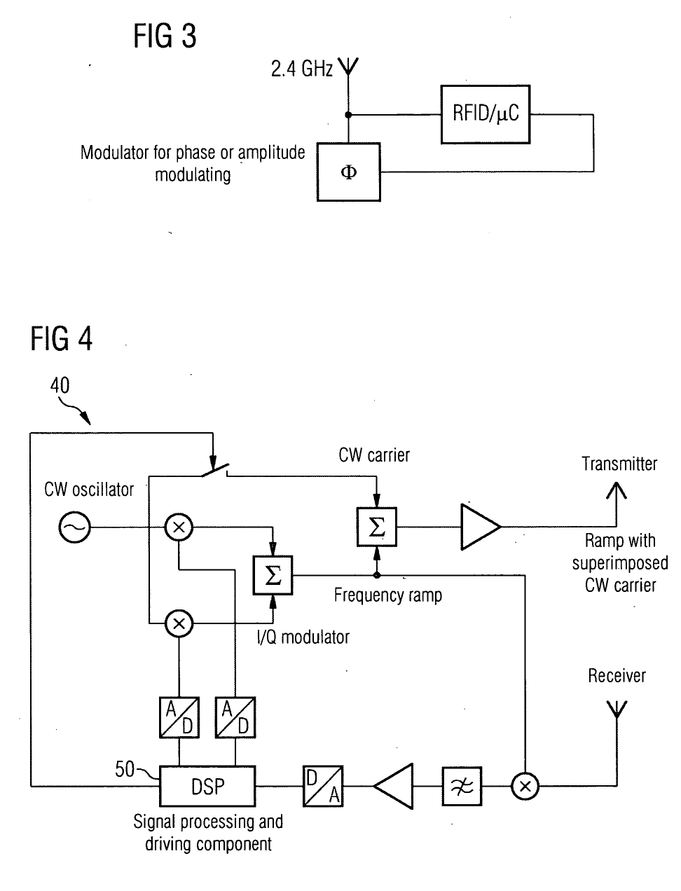

FIG. 3 shows the embodiment variant of a structure of the locatable backscatter transponder,

FIG. 4 is an exemplary circuit arrangement for the base station,

FIG. 5 is an exemplary block diagram of a passive backscatter transponder and of the modulation of the antenna's effective echoing area,

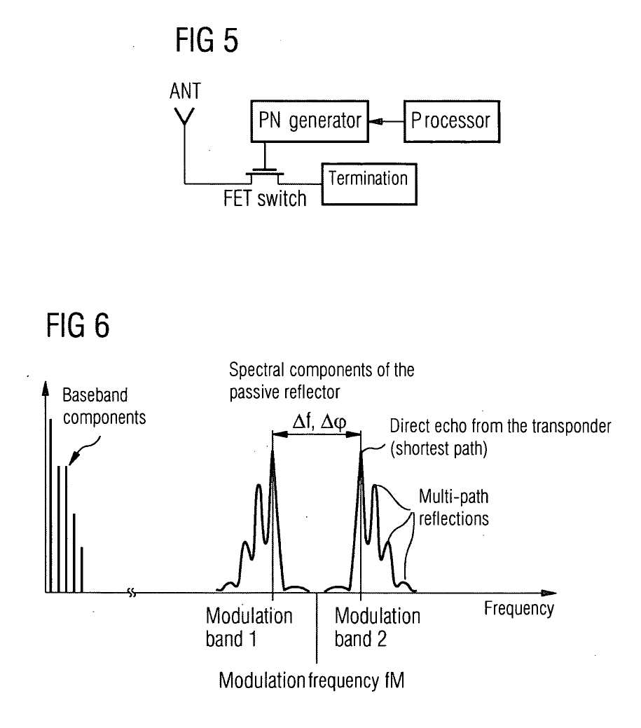

FIG. 6 is a spectral representation of a locatable RFID transponder's distance spectrum,

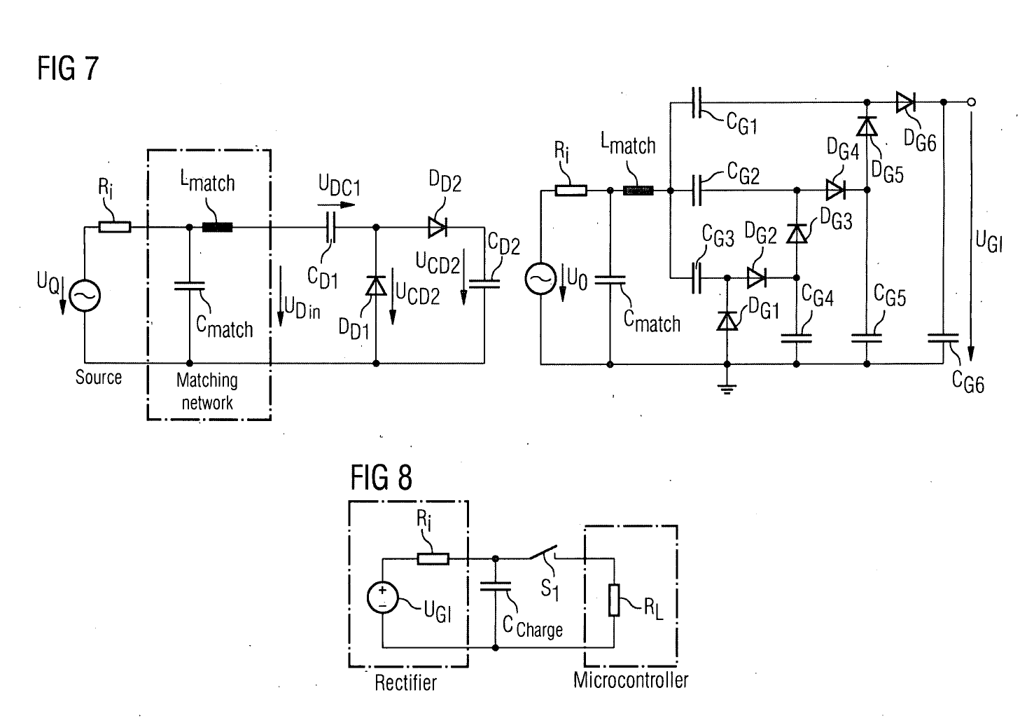

FIG. 7 shows an embodiment variant of a rectifier having a voltage doubler (left) as well as a voltage sextupler (right) in the backscatter transponder, and

FIG. 8 shows an embodiment variant of an energy accumulator for temporary feeding with higher voltages.

With the aid of the present invention it is possible to feed a backscatter transponder with energy via a base station and a high-power narrowband radio signal. A broadband radio signal is emitted by the base station simultaneously or alternately with the narrowband radio signal in order to perform FMCW (Frequency Modulated Continuous Wave) distance measuring between the base station and backscatter transponder. For approval reasons the power of said broadband radio signal is lower than that of the narrowband radio signal and is in the ISM (Industrial, Scientific, and Medical) band. It is possible on that preferably systematic basis to enable both energy supplying when the distance between the transponder and base station is relatively large (approximately 5 m) and locating of the transponder on the FMCW backscatter principle within one system. To keep the circuitry overhead for the base station and backscatter transponder low, the same frequency range can preferably be used for locating the backscatter transponder and for supplying it with energy. The resulting advantage is that just one antenna and one transmitter/receiver will be required on the backscatter transponder side.

FIG. 1 is a schematic of the structure of the backscatter system with the autonomously powered, locatable backscatter transponder 1. The backscatter transponder 1 is supplied with energy via the HF (High Frequency) field (for example 2.4 GHz) of the base station 40. With the aid of said energy, which the backscatter transponder 1 draws from the radio signal emitted by the base station 40, sensors 90 are fed and their measured variables registered and transmitted to the base station 40. Examples of sensors of said type are a pressure sensor, a temperature sensor, a vibration detector, and a brightness sensor. Other sensors are, though, also conceivable provided they can be fed adequately by means of the energy available to the backscatter transponder 1. The backscatter transponder 1 can furthermore be located by the base station 40, which is to say that a method is provided for wirelessly or contactlessly measuring the distance between the base station 40 and backscatter transponder 1.

FIG. 2 is a technical block diagram of an embodiment variant of the backscatter transponder. The backscatter transponder 1 consists of an energy supply 10, a control means 20 for a microcontroller 25, a sensor data registering means, and a backscatter 30 for modulating and backscattering a radio signal component for transmitting data, and a radio signal component for measuring distance. On that structural basis the backscatter transponder 1 combines distance measuring based on propagation delay with supplying energy from the radio field surrounding it or from that emitted by the base station 40. It can also supply connected sensors 90 with energy and read them out and in that way forms an identifiable, autonomously powered and locatable backscatter transponder 1. The basic principle of locating by the base station 40 of the backscatter transponder 1 based on propagation delay is described in DE 199 46 161 A1.

A technical requirement placed on the described backscatter transponder 1 is for locating based on propagation delay to take place in accordance with the resolution formula

$${d}_{m i n} = \frac{c}{2 \times B}$$

at a largest possible bandwidth B, where dₘᵢₙ stands in the above formula for the resolving power while c symbolizes the speed of light. Owing to the range requirements the backscatter transponder 1 should furthermore be supplied with energy at maximum power. Locating based on propagation delay or FMCW (Frequency Modulated Continuous Wave) locating of the backscatter transponder 1 has to rely in the UHF range on the ISM bands not subject to approval (for example 2.4 GHz) owing to the bandwidth available there. However, the ISM bands only allow a maximum power of around 10 mW for broadband, which does not suffice for supplying the backscatter transponder 1 with energy via the radio field of the base station 40.

According to an embodiment variant of the present invention, the base station 40 is therefore configured in such a way as to emit both a high-power narrowband radio signal and a low-power broadband radio signal within the same frequency range. A narrowband radio signal having a width of around 8 MHz is preferably sent by the base station 40 in the 2.4 GHz range. Said narrowband radio signal transmits a power of approximately 4 W within a frequency range of, for instance, 2.446 to 2.454 GHz. The base station 40 furthermore transmits a broadband radio signal for locating in the ISM band. Said broadband radio signal transmits a power of around 10 mW within a frequency range of preferably 2.4 to 2.483 GHz.

Whereas the narrowband radio signal emitted by the base station 40 and registered by the backscatter transponder 1 serves only to supply the backscatter transponder 1 with energy via the radio field, a ramp for FMCW radar locating of the backscatter transponder 1 is produced by the base station 40. The narrowband and broadband radio signals can be emitted and received by the base station 40 and backscatter transponder 1 in parallel and continuously but also alternately. If the backscatter transponder 1 is supplied with energy in parallel with locating implemented by means of the broadband radio signal, then the region around the high-power carrier must be masked out in the radio signal by software means, which will effectively result in a bandwidth reduction and hence an adverse effect on resolution.

By both supplying the backscatter transponder 1 with energy and locating it within the same frequency range, just one antenna and receiving unit will be needed in the backscatter transponder 1. That will reduce the structural overhead for the backscatter transponder 1 as well as its space requirements.

FIG. 3 is a schematic of an embodiment variant of the backscatter transponder 1. The RFID unit with a microcontroller generates the specific modulation clock which is triggered by means of a phase modulator (PM=Phase Modulation, PSK=Phase Shift Keying) or amplitude modulator (AM=Amplitude Modulation). The system consisting of the base station 40 and backscatter transponders can furthermore be embodied having bulk reading capability so that the modulator can be activated selectively via the received data to enable selective addressing of individual backscatter transponders 1 within the reading range of the base station 40. It is also possible to save energy with that function. The above-cited bulk reading capability, referred to also as multi-access, can be achieved by way of, for example, Frequency Division Multiple Access (FDMA), Time Division Multiple Access (TDMA), or Code Division Multiple Access (CDMA). Particularly during intermittent or switchover or alternating operation it is possible via a downlink, which is to say a data transfer from the base station 40 to the backscatter transponder 1, to agree a type of protocol and an operating mode guaranteeing multi-tag capability, meaning use of a plurality of transponders in conjunction with one base station. In this connection it is advantageous to form a combination with the energy supply from the radio network. For that purpose the downlink data stream from the base station 40 to the backscatter transponder 1 is impressed on the radio signal for supplying the backscatter transponder 1 with energy. The data is then conveyed from the backscatter transponder 1 to the base station 40 in a multi-tag-enabled uplink via the impression in the reflected FMCW interrogation signal.

In terms of the frequency bands used, the backscatter system consisting of the base station 40 and backscatter transponder 1 is embodied preferably in two versions: 1) Two separate bands are used for supplying the backscatter transponder 1 with energy and for locating it. The energy is preferably supplied at a frequency of 869 MHz and locating performed in the 2.4 GHz ISM band. This has the advantage that at the low frequency at which the energy is supplied the efficiency of the diode rectifier circuitry will be greater for utilizing the radio field energy and that, furthermore, no interference due to the strong CW carrier can occur in the base station. Locating at 2.4 GHz can be performed at the full ISM bandwidth of 80 MHz.

In the second version, the same frequency range is used for supplying the backscatter transponder 1 with energy and for locating it. Said frequency range is preferably in the 2.4 GHz range with the advantage that the backscatter transponder 1 requires just one antenna and one receiver and so can be embodied extremely simply.

FIG. 4 is a block diagram relating to a preferred base station 40 according to the above-cited second version. In this block diagram a CW oscillator is used for producing the powerful monofrequent carrier signal for supplying the backscatter transponder 1 with energy. The ramp signal required for FMCW distance measuring is simultaneously derived therefrom via an I/Q mixer. Both signals are radiated by means of a common transmitting antenna. The radiated ramp is mixed in the receiver branch of the base station 40 with the backscattered and modulated signal received from the backscatter transponder 1. The resulting signal supplies a spectrum like that shown by way of example in FIG. 6. The measured distance between the base station 40 and backscatter transponder 1 can be derived directly from said spectrum.

As can be seen from the block diagram in FIG. 5, the interspersed radio signal is phase- or amplitude-modulated by the modulator in the backscatter transponder 1. It follows therefrom that the backscatter transponder 1 acts as a backscatter and so can be used for propagation delay measuring and for locating the same. Said propagation delay measuring on the backscatter principle is based on the disclosure in DE 199 46 161.

By linking the energy supply of the backscatter transponder 1 from the radio field and the above-described implementation of the base station 40 it is possible by means of a totally passive backscatter transponder having just one receiver unit to ensure locating precise to within one centimeter up to a distance of approximately five meters between the base station 40 and backscatter transponder 1 as well as simultaneous transmitting of data from, for example, an additional detecting element or sensor between the backscatter transponder and base station 40. Said combining results in an economical and simple base station 40 that makes it possible to locate totally passive transponders with high precision and at the same time read out measured variables in an autonomously powered manner. The entire backscatter system consisting of the base station 40 and backscatter transponder 1 is furthermore capable of gaining approval for radio applications. In its “semi-passive” embodiment the backscatter transponder 1 is supplied with energy and achieves ranges up to approximately 15 m.

A preferred embodiment variant of the energy supply from the radio network in the backscatter transponder 1 consists of the components of an interface circuit, a rectifier, an energy accumulator, a charge pump, and a trigger component. FIG. 7 shows the rectifier used, which can be embodied also as a voltage multiplier in cascaded form in order to provide a higher output voltage. Specifically in terms of the energy to be obtained from the radio network, the following dimensioning criteria are of significance in selecting the rectifier diodes: low junction capacitance of ideally less than 100 fF, low series resistance of ideally less than 10 Ohm, low reverse current for the diodes and a low threshold voltage of ideally 350 mV. Integrated rectifier packages could be used as a supplementary optimizing means.

What is preferred according to a further embodiment variant in order to further increase the output voltages achieved by the energy supply of the backscatter transponder 1 and hence its range is to employ an energy accumulator of the type shown by way of example in FIG. 8 in the backscatter transponder 1. In said energy accumulator the energy is collected in a capacitor. The switch S1, which is implemented in the form of a low-loss trigger circuit, is closed once a specific electric voltage has been reached. Through said preferred embodiment, the backscatter transponder 1 can be temporarily supplied at a greater distance from the base station 40, thereby enabling greater ranges of the backscatter transponder 1 to be achieved than would be allowed by the energy supply from the radio network.

1.-15. (canceled)

16. A backscatter transponder, comprising:
an energy supply to feed the backscatter transponder with energy based upon a HF field of a base station;
a control device to transmit energy from the energy supply to a sensor to read out measured values of the sensor; and
a distance measuring device to measure contactless a distance between the base station and the backscatter transponder.

17. The backscatter transponder as claimed in claim 16, wherein the energy supply is supplied with energy based upon a narrowband radio signal, and wherein the contactless distance measuring is based upon a broadband radio signal.

18. The backscatter transponder as claimed in claim 16, wherein the backscatter transponder has one antenna and one transmitter/receiver, wherein the energy supply and the device for distance measuring are supplied via the same frequency range of a base station's radio signal.

19. The backscatter transponder as claimed in claim 18, wherein the energy supply is supplied based upon a narrowband radio signal having a first power, and wherein the device for distance measuring is supplied based upon a broadband radio signal having a second power less than the first power.

20. The backscatter transponder as claimed in claim 19, wherein the narrowband radio signal is in a 2.4 GHz range and has a width of 8 MHz, and wherein the broadband radio signal is in the 2.4 GHz range and has a width of 80-90 MHz.

21. The backscatter transponder as claimed in claim 19, wherein the narrowband radio signal is in between 2.446 GHz and 2.454 GHz, and wherein the broadband radio signal is in between 2.4 GHz and 2.483 GHz.

22. The backscatter transponder as claimed in claim 19, wherein the narrowband radio signal and the broadband radio signal are registered by the backscatter transponder continuously.

23. The backscatter transponder as claimed in claim 19, wherein the narrowband radio signal and the broadband radio signal are registered by the backscatter transponder alternately.

24. The backscatter transponder as claimed in claim 16, wherein the distance is measured based upon a FMCW radar locating measurement of the backscatter transponder.

25. The backscatter transponder as claimed in claim 16, wherein the energy supply is based on a frequency of 869 MHz, and wherein distance measuring is based on a 2.4 GHz ISM band.

26. The backscatter transponder as claimed in claim 16, wherein the backscatter transponder is a semi-passive transponder.

27. The backscatter transponder as claimed in claim 16, wherein the sensor is a brightness sensor.

28. The backscatter transponder as claimed in claim 16, wherein the sensor is selected from the group consisting of a pressure sensor, a temperature sensor, a vibration sensor, and a combination thereof.

29. A base station for producing and registering radio signals in communication with a backscatter transponder, comprising:
a receiver to receive a radio signal emitted by a backscatter transponder;
a transmitter to radiate first radio signals in a first frequency band for supplying the backscatter transponder with energy and to radiate second radio signals in a second frequency band for locating the backscatter transponder; and
a signal processing and driving component.

30. The base station as claimed in claim 29, wherein the first radio signal is a narrowband radio signal having a first power level, and wherein the second radio signal is a broadband radio signal having a second power level, wherein the second power level is less than the first power level.

31. The base station as claimed in claim 30, wherein the first radio signal is in a 2.4 GHz range and has a bandwidth of 8 MHz, and wherein the second radio signal is in a 2.4 GHz range and has a bandwidth of 80 to 90 MHz.

32. The base station as claimed in claim 30, wherein the first radio signal is a 869 MHz signal and the second radio signal is in a 2.4 GHz ISM band.

33. The base station as claimed in one of claim 29, wherein the first and second radio signals are radiated continuously or alternately.

34. The base station as claimed in claim 29, wherein a FMCW radar locating is based upon the second radio signal.
